(19) United States
(12) Patent Application Publication
(10) Pub. No.: US 2008/0303474 A1
(43) Pub. Date: Dec. 11, 2008

(54) SYSTEMS AND METHODS FOR CONTROLLING LIMITED ROTATION MOTOR SYSTEMS

(75) Inventor: Adam I. Pinard, Carlisle, MA (US)

Correspondence Address: GAUTHIER & CONNORS, LLP, 225 FRANKLIN STREET, SUITE 2300, BOSTON, MA, 02110, US

(73) Assignee: GSI GROUP CORPORATION, Billerica, MA (US)

(21) Appl. No.: 11/759,989

(22) Filed: Jun. 8, 2007

(51) Int. Cl. G05B 19/29

(52) U.S. Cl. 318/600

(57) ABSTRACT

A control system is disclosed for controlling the movement of a limited rotation motor. The control system includes a computer system and a closed-loop motor controller. The computer system is for generating command digital data including digital input commands for controlling the movement of the limited rotation motor. The closed-loop motor controller includes an input circuit for receiving the command digital data synchronous with a data input signal, a digital control system for processing the command digital data, an output circuit for providing a motor drive signal to the limited rotation motor, and a feedback circuit for providing digital feedback data to said digital control processing circuit. The digital control processing circuit providing closed-loop motor control calculations on a computation cycle that is synchronous with the data input signal.

### BACKGROUND

The present invention generally relates to limited rotation motors, and relates in particular to systems for controlling limited rotation motors.

Limited rotation motors generally include stepper motors and constant velocity motors. Certain stepper motors may be employed in applications requiring high speed and high duty cycle sawtooth scanning at large scan angles. For example, U.S. Pat. No. 6,275,319 discloses an optical scanning device for raster scanning applications.

Limited rotation motors for certain applications, however, require the rotor to move between two positions with a precise and constant velocity rather than by stepping and settling in a sawtooth fashion. Such applications require that the time needed to reach the constant velocity be as short as possible and that the amount of error in the achieved velocity be as small as possible. Constant velocity motors generally provide a higher torque constant and typically include drive circuitry for causing the rotor to rotate about a central axis, as well as a position transducer, e.g., a tachometer or a position sensor, and a feedback circuit coupled to the transducer that permits the rotor to be driven by the drive circuitry responsive to an input signal and a feedback signal. For example, U.S. Pat. No. 5,424,632 discloses a conventional two-pole limited rotation motor that includes a feedback circuit.

Such limited rotation motors may be used, for example, in a variety of laser scanning and processing applications, such as high speed surface metrology, laser welding (e.g., high speed spot welding), surface treatment, cutting, drilling, marking, trimming, laser repair, rapid prototyping, forming microstructures, or forming dense arrays of nanostructures on various materials.

The processing speeds of such systems are typically limited by one or more of mirror speed, X-Y stage speed, material interaction and material thermal time constants, the layout of target material and regions to be processed, and software performance. Generally, in applications where one or more of mirror speed, position accuracy, and settling time are factors that limit performance, any significant improvement in scanning system open loop gain may translate into immediate throughput improvements.

The controllers for such systems must also typically be designed and constructed to fully optimize the performance of the limited rotation motor system. Controllers that employ analog electronics are generally able to control the motor systems in real time, but analog control systems must generally be specifically designed for each system, requiring fine adjustment of control parameters. Analog control systems also limit flexibility in changing the amount and character of feedback that may be available from such control systems.

Digital control circuits may be used to generate command signals in the form of pulses as disclosed, for example in U.S. Pat. No. 4,282,468, which also discloses the use of analog feedback signals that are generated using a quadrature phase resolver. Digital controllers may also be employed with digital-to-analog (D/A) converters as disclosed, for example, in U.S. Pat. No. 4,893,068, which discloses a digital servo position system that employs an integrator to switch between either velocity error or position error.

Digital signal processors may also be used in digital controllers together with D/A converters for driving limited rotation motors. FIG. 1, for example, shows a laser processing system 10 that employs two limited rotation motors 12 (x-axis) and 14 (y-axis) that are coupled to mirrors 13 and 15 respectively for guiding a laser beam 16, which is produced by a laser source 18, toward an imaging surface 22. The system also includes a linear-actuator motor 20 (z-axis) for adjusting the focal area of the laser beam along the optical axis. The control of the x scan direction motor 12, the y scan direction motor 14, and the z scan motor 20, are provided by an analog x driver 11, an analog y driver 13 and an analog z driver 19 respectively. The turning on and off of the laser source 18 is provided by a laser trigger unit 17. Each of the drivers 11, 13 and 19 is coupled via a digital-to-analog (D/A) converter 5, 7 and 9 respectively to a real time serial bus demultiplexor 3. The laser trigger unit 17 is coupled to the demultiplexor 3 as well.

During use, asynchronous commands (e.g., x, y, z, and laser data) from a control computer 25 are sent to a timing unit 21 that includes a first-in-first-out stack 23. The commands are then sent along a real time serial data bus to the multiplexor 3, where digital data for the x, y, and z motors is provided to the D/A converters 5, 7 and 9 respectively, and corresponding analog control signals are then provided to the analog controllers 11, 13 and 19 respectively. Laser trigger data is provided directly to the laser trigger unit 17 from the multiplexor 3.

The commands provide position change information regarding a mark or cut that is to be made on the imaging surface. The control system of FIG. 1 directs the x scanner 14, they-scanner 12 and the z-scanner 20 to move accordingly, and to turn on and off the laser source (e.g., to switch between a low and high or above a marking threshold value) responsive to the input command and responsive to the movement of the imaging surface at the target plane. The system may also include position detectors within each motor 12, 14 and 20 that each provide position detection signals back to the respective controllers 11, 13 and 19, as well as to the laser trigger unit 17.

The feedback from the motors may be provided as either digital or analog signals. For example, U.S. Pat. No. 4,398,241 discloses a digital signal processor based control system in which the feedback signals are provided as a sequence of pulse signals, and U.S. Pat. No. 7,200,464 discloses a digital signal processor based control system in which the feedback signals are provided as analog signals that are converted to digital signals using A/D converters.

Digital processing units that include micro processors generally perform multiple processing tasks such as managing inputs and outputs, user interfaces, and receiving and responding to interrupt signals. To handle these tasks, the processing units typically employ time-multiplexed multitasking, but such multi-tasking limits the availability of the processor to the controller interface. The speed of operation of the limited rotation motor, therefore, needs to rotate relatively slowly to ensure that the next output signal will always be available when needed. The coupling of any feedback signals to the associated output signal would also require a relatively slow speed of operation. Further, unwanted noise from execution of the motor command signals may adversely affect the analog or digital feedback signals.

The generation of status information is also sometimes adversely affected by operation of the device itself or of other devices due to electrical interference or switching noise in the device. Faster motors typically require substantially larger heat sinks, and may result in substantial interference that may adversely affect feedback information that is generated by the devices since amplifier power is proportional to the square of the speed. For example, noise created in the amplifier may couple into the position detector, be amplified and cause either instability or unwanted movement of the scanning system.

There continues to be a need, therefore, for a controller for limited rotation motors and for laser processing systems that enable real time feedback and more flexibility in the control and feedback operations to further optimize the performance of the limited rotation motor system.

### SUMMARY

The invention provides a control system for controlling the movement of a limited rotation motor. The control system includes a computer system and a closed-loop motor controller. The computer system is for generating command digital data including digital input commands for controlling the movement of the limited rotation motor. In accordance with an embodiment, the closed-loop motor controller includes an input circuit for receiving the command digital data synchronous with a data input signal, a digital control system for processing the command digital data, an output circuit for providing a motor drive signal to the limited rotation motor, and a feedback circuit for providing digital feedback data to said digital control processing circuit. The digital control processing circuit providing closed-loop motor control calculations on a computation cycle that is synchronous with the data input signal.

In accordance with another embodiment, the closed-loop motor controller includes an input circuit for receiving the command digital data control signal for processing the command digital data, an output circuit for providing a motor drive signal to the limited rotation motor, and a feedback circuit for providing feedback digital data to the digital control system. The output circuit is synchronous with the feedback circuit such that feedback input data is read from the limited rotation motor only when the motor control signal is not changing.

In accordance with a further embodiment, the invention provides a method of controlling movement of a limited rotation motor that includes the steps of generating command digital data including digital input commands for controlling the movement of the limited rotation motor, generating a timing signal, executing closed-loop motor control calculations responsive to each digital input command on a computation cycle that is synchronous with the timing signal to provide an motor drive signal for controlling the movement of the limited rotation motor, and receiving feedback information from the limited rotation motor such that said closed-loop motor control calculations are responsive to each digital input command and responsive to the feedback information from the limited rotation motor.

### BRIEF DESCRIPTION OF THE DRAWINGS

The following description may be further understood with reference to the accompanying drawings in which:

FIG. 1 shows an illustrative diagrammatic view of a prior art laser scanning or marking system;

FIG. 2 shows an illustrative diagrammatic view of a control system in accordance with an embodiment of the invention;

FIGS. 3A-3C show graphical representations of a frame-strobe signal, a command data stream comprising micro-vectors, and the data for a single micro-vector respectively;

FIG. 4 shows an illustrative diagrammatic view of a motor controller of FIG. 2;

FIG. 5 shows an illustrative flow-chart of portions of the operation of a motor controller shown in FIG. 4;

FIG. 6 shows graphical timing chart representations of clock signals, synchronization signals, data retrieval cycles, computation cycles, feedback data generation cycles, and motor and system control signals in a motor controller as shown in FIG. 4;

FIGS. 7A and 7B show illustrative diagrammatic views of a micro-vector processing example involving a wait command in a control system of an embodiment of the invention; and

FIGS. 8A-8C show illustrative diagrammatic views of a further micro-vector processing example involving a trigger command in a control system of an embodiment of the invention.

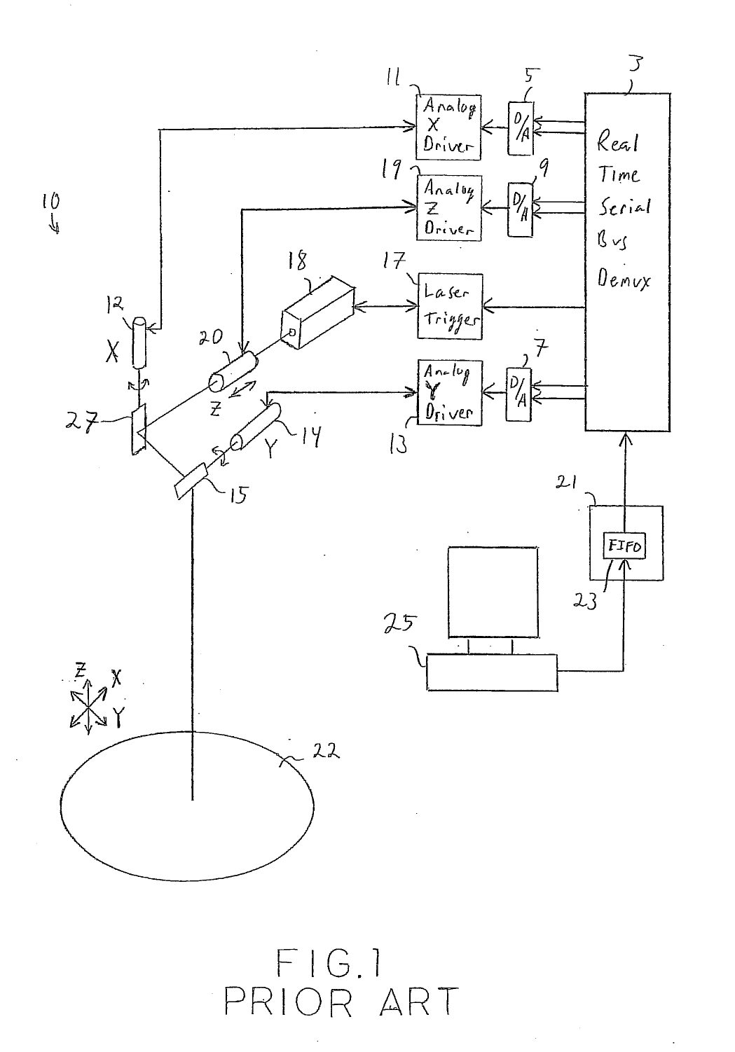

The drawings are shown for illustrative purposes only.

### DETAILED DESCRIPTION OF THE ILLUSTRATED EMBODIMENTS

Laser marking or scanninig systems typically require synchronized motion between multiple axes. Generally, the desired motion of the laser is broken into coordinate sets called micro-vectors that are spaced evenly in time. The time interval between the sets is referred to as the command sample rate, and the coordinate set for each sample period is the micro-vector. These micro-vectors may be calculated in a computer, then either converted to an analog voltage with a D/A card in the computer and transmitted over analog signal lines, or transmitted digitally over a proprietary synchronous communication channel to a D/A converter adjacent to the servo controller. Both of these solutions require a specialized card in the computer, and custom cables from the computer to the servo controller.

Applicant has discovered that high motor control speeds, substantial programming flexibility and real-time feedback may be provided in a control system for limited rotation motors. The invention provides for the generation of command and feedback micro-vector data for servo controllers in limited rotation torque motors for optical scanning. In accordance with various embodiments, the invention provides a system and method for synchronizing continuous command and status information with intermittent command and status generation using event markers.

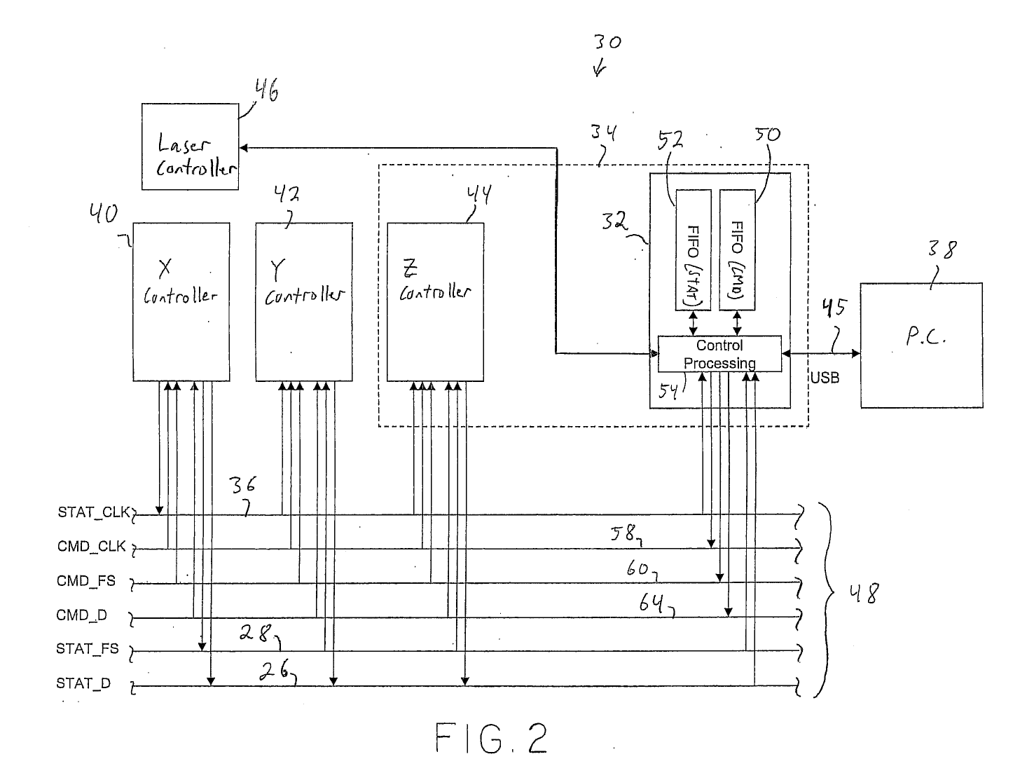

FIG. 2 shows a control system 30 in accordance with an embodiment of the invention that includes an asynchronous command generation portion, a synchronous command execution and feedback portion, and a bridge portion between the asynchronous and synchronous portions. In particular, the asynchronous portion includes a personal computer 38 that is coupled to a bridge portion that includes a bridge unit 32 by any conventional means such as, for example, a serial connection using a universal serial bus (USB) 45. The synchronous portion includes a plurality of controllers such as an x-servo controller 40, a y-servo controller 42, and a z-servo controller 44 that are coupled to the bridge unit 32 by, for example by a high speed communication interface (HSCI) connection bus system 48. The synchronous portion of the system also includes a laser controller 46 that is coupled to the bridge unit. As shown at 34, the bridge unit 32 may be included on the same circuit board as one or more of the controllers (e.g., the z-motor controller 44).

Command signals are generated by a control program in the personal computer 38, and forwarded to a control processor 54 in the bridge unit 32 where they are stored in a first-in-first-out (FIFO) stack 50. The FIFO stack 50 provides that asynchronous communication from the personal computer 38 (that may, for example, be due to the processor in the personal computer 38 handling multiple tasks using time division multiplexing), are successively made available to the HSCI bus 48 without interruption.

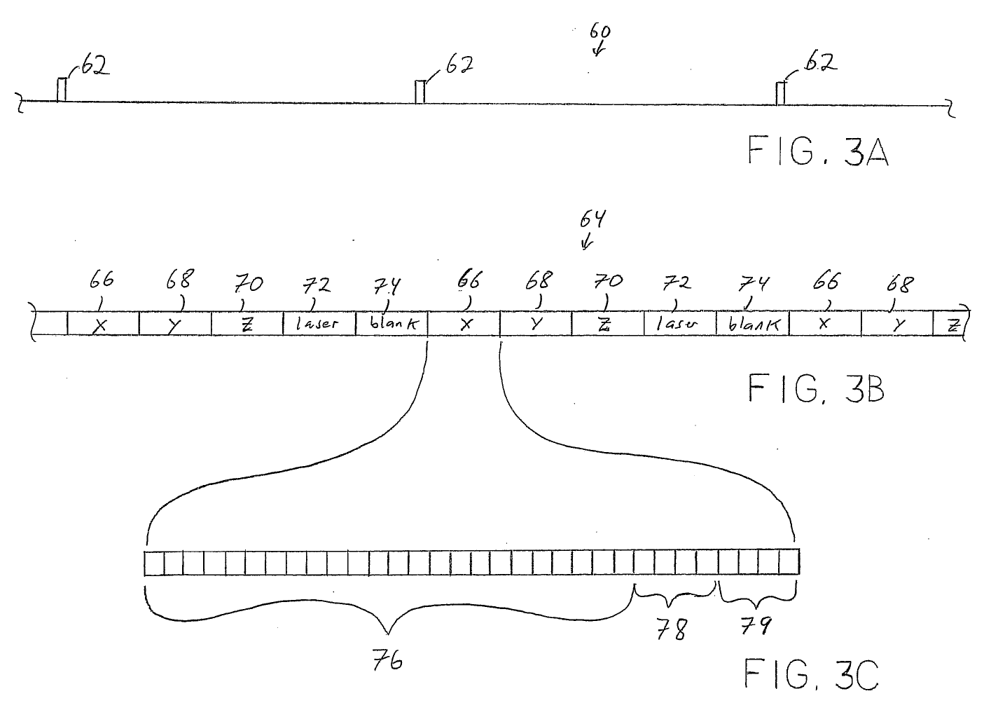

As further shown in FIGS. 3A and 3B, the control processing unit 54 produces a command clock signal 58 and a command frame synch signal 60 that includes command frame pulses 62 as further shown in FIG. 3A. Between each of the command frame pulses 62, the command data signal 64 provides x position data 66, y position data 68, z position data 70, and laser trigger data 72. Each set may also include an unused micro-vector 72 that may be employed by specific users for controlling other equipment in various further embodiments. As shown in FIG. 3C, a command micro-vector of, for example, an x position, may include twenty four bits of command position data as shown at 76, four bits of communication code data as shown at 78, and four bits of tag data as shown at 79. The communication code data is employed to direct specific position control data to the appropriate controller as discussed further below, and the tag data is employed to provide additional instructions to the bridge and/or to each controller regarding timing as discussed further below.

As shown in FIG. 2, the bridge processing unit 54 provides the command clock signal 58, the command frame synch signal 60 (e.g., at 1/256 of the command clock signal), and the command data 64 to the bus 48. One of the controllers (e.g., the x-controller), generates a status clock signal 36 and a status frame synch signal 28 that is used for providing feedback information. The status clock signal 36 and status frame synch signal 28 are read by each of the other controllers as well as by the bridge processor 54. Status data 26 is returned from each of the controllers 40, 42, 44 and 46 to the bridge processing unit 54, and then to the central computer 38 via a FIFO stack 52 as shown.

The system, therefore, employs two different clock signals; the command clock signal (CMD_CLK) 58 and the status clock signal (STAT_CLK) 36. The command clock signal is used to generate the command frame synch signal (CMD_FS), and each frame is divided into sub-frames that are, for example, thirty two bits each. Four sub-frames are shown in FIG. 3C (for x, y, z and laser data), but any number of sub-frames of at least the number of controllers may be employed. For example, in certain embodiments eight sub-frames (including for example, four unused micro-vectors) may be employed to provide a generous amount of buffer time in each sub-frame for providing feedback (status) information as discussed in more detail below.

The status clock signal (STAT_CLK) 36 and the status frame synch signal (STAT_FS) are generated by one of the controllers, for example by the controller that is physically located furthest from the bridge unit. Each frame is divided into the same number of thirty two bit sub-frames of status data (STAT_D) as there are sub-frames of command data.

The STAT_CLK, STAT_FS and STAT_D signals, therefore, are generated by one of the controllers (e.g., the x controller), and the CMD_CLK, CMD_FS and CMD_D signals are generated by the bridge processing unit. The status clock signal, may for example, be a nominal 24 MHz signal, and is used to receive status information as well as to provide synchronization of pulse width modulation signals and data conversions by A/D converters in the motor controller circuits.

The status frame synch signal provides a pulse once per frame generated by one of the servo drivers. The status frame synch signal locks to the command frame synch signal issued by the bridge. The status data signal is a serial stream of data from the motor controllers that is provided to the bridge using the status frame synch and status clock signals for control. It is driven by the servo drivers with real time information representing the servo system at the beginning of the frame. The first sub-frame is channel 0, and the second is channel 1 etc.

The command clock signal is transmitted by the bridge and is generated by buffering and deglitching the status clock signal received from the last motor controller. The command frame synch signal is generated by the bridge by counting 256 command clock signals, and yields a sampling frequency of about 93.75 kHz. The command data signal is the serial data stream of (e.g., 8) thirty two bit micro-vectors in a frame. It is driven by the servo drivers with real time information representing the servo system at the beginning of each frame. The first sub-frame is channel 0, and the second is channel 1 etc.

The command data and status data transmit data by assigning each controller a channel in a frame. The current status data channel servo drives the bus for thirty two bits and then tri-states its output yielding to the other channels. The command data is driven from the bridge for the entire frame, and then respective servo controllers latch their data during their channel period.

The laser signals are separated from the data stream by the bridge, and are directed to the laser for control. As discussed above, the bridge functions may be provided in any of the servo controllers by programming the inherent field programmable gate array (FPGA) or microprocessor with the required functions, and also buffer the data both ways on an asynchronous bus to a computer. In alternative embodiments, the bridge may stand alone or the bridge may be programmed into the direct output of a system computer. The bridge, for example, may be a logic card plugged into the PCI bus of a computer. The HSCI bus may be linked to one of the controllers showing the command clock, command frame synch and command data that are connected for input to command processor latch, and the status clock, status frame synch and status data are provided for status output via a latch. An A/D synchronization signal is derived from the command frame synch signal, and synchronizes the D/A activity of each controller, and further synchronizes the pulse width modulation motor output stage.

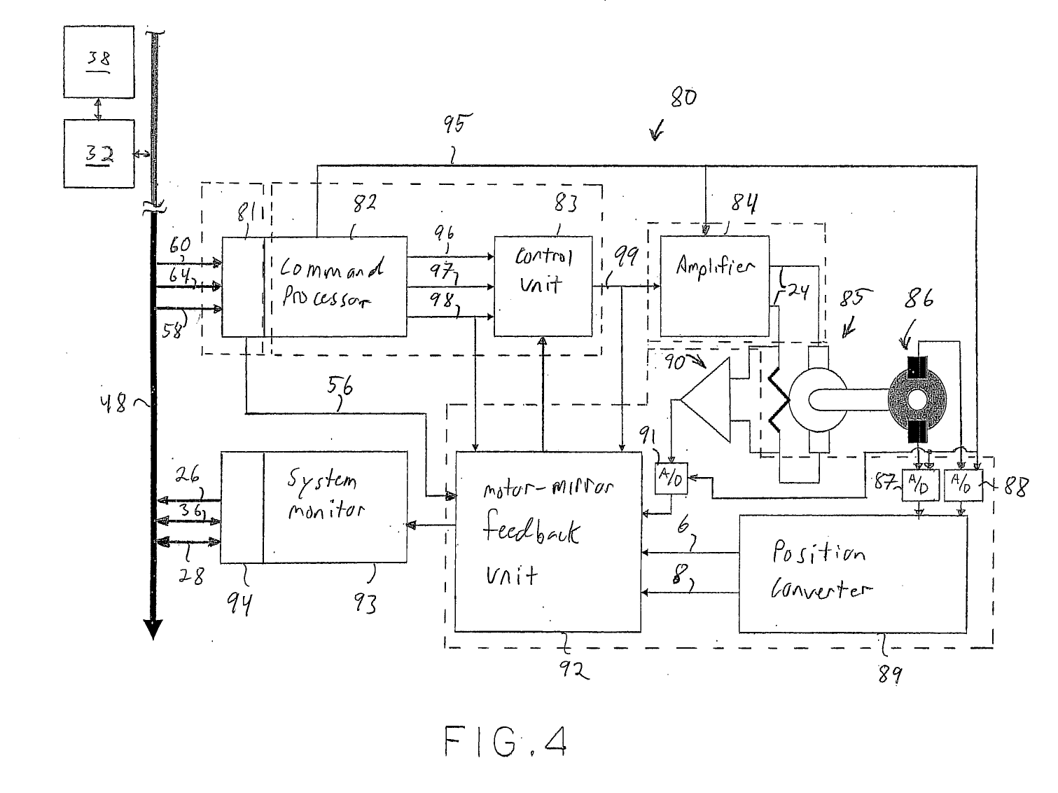

In particular, FIG. 4 shows a controller 80 that may be used for each of the controllers 40, 42 and 44, with the status clock signal 36 and status frame synch signal 28 being provided to the bus 48 if the controller is controller 40, and being read from the bus 48 if the controller is either of controllers 42 or 44. The controller 80 generally includes an input circuit 310, a computation circuit 320, an output circuit 330, and a feedback circuit 340.

The input circuit 310 includes a latch-in unit 81 for latching in from the bus 48 the appropriate command data signal 64 for the channel assigned to the controller, as well as the command clock signal 58 and command frame synch signal 60. The latch-in unit 81 looks for the micro-vector in each frame that is assigned to that controller, and latches in the thirty two bit command data for that channel responsive to the command frame synch signal.

The computation circuit 320 includes a command processor unit 82 and a control unit 83. The command processor unit 82 generates a command acceleration signal 96, a command velocity signal 97 and a command position signal 98 to the control unit 83. The command processor 82 determines whether the next position command requires the servo to move beyond any of an acceleration limit, a velocity limit or a jerk limit. If not, a command voltage is passed to the control unit 83, which in turn passes a command voltage to an amplifier 84 of the output circuit 330, which in turn drives the motor 85 with the appropriate pulse width modulated signal. Specifically, the acceleration, velocity and position signals are provided by the processor 82 to the control unit 83, and the position signal is also provided to the motor-mirror feedback unit 92. The command voltage output from the control unit 84 is also provided to the motor-mirror feedback unit 92 of the feedback circuit 340 to provide command information against which motor control feedback information is compared.

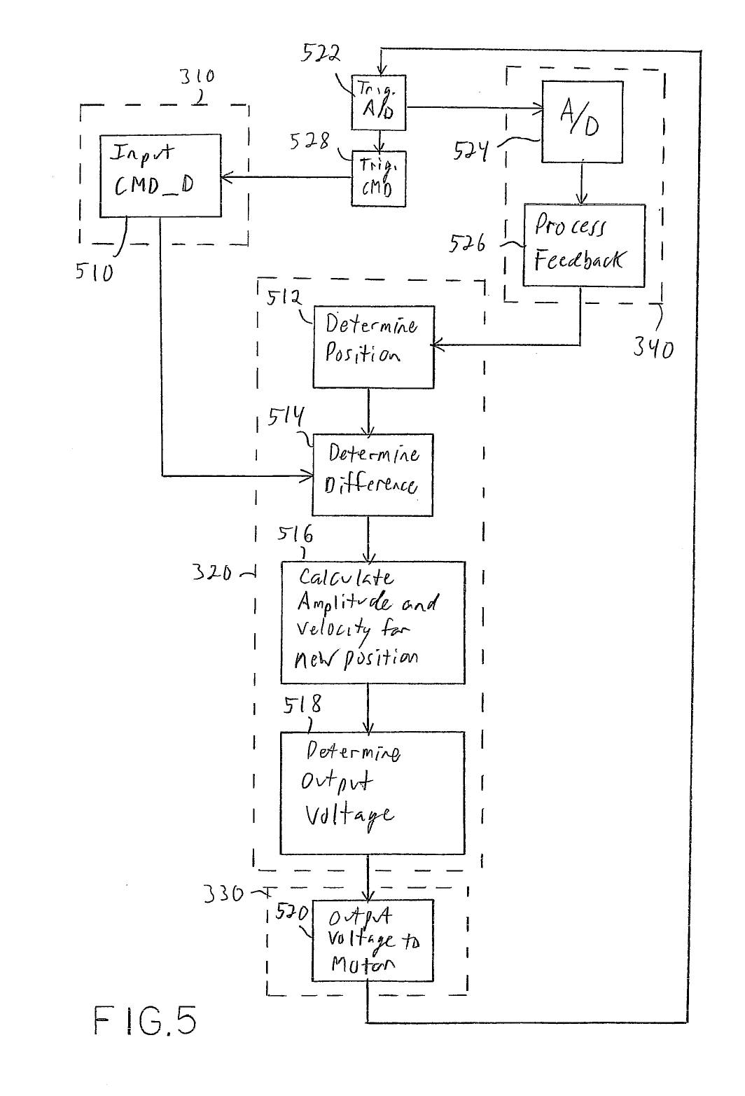

As shown in FIG. 5, the input circuit 310, computation circuit 320, output circuit 330 and feedback circuit 340 function together to control the motor as follows. Command data is input to the latch-in unit 81 (step 510) of the input circuit 310 responsive to a command trigger signal pulse. At the same time feedback data is provided from the feedback circuit 340, and the current position is determined (step 512). A difference is then determined (step 514) between the command position that was received by the latch-in unit and the current position as determined in step 512. The system then calculates an amplitude and velocity at which the motor should move to drive the laser to the new position (step 516), and then determines a voltage (step 518) that should be applied to the motor. The determined voltage is then output to the output circuit 330, and is applied to the motor (step 520). Feedback from the motor is provided to the feedback circuit 340 via an A/D trigger signal (step 522), which causes A/D converters to provide digital feedback to a feedback processing system that may include the position converter 89 and/or the feedback unit 92. A command data trigger signal is then provided (step 528) to the input circuit 310, and the system repeats its cycle.

Pulse width modulation is employed in driving certain motors in order to optimize high speed operation without substantially increasing the required power required by the amplifier. Pulse width modulation provides that a power signal (e.g., voltage) is on at full power for a percent of an operational duty cycle that equals the value of the motor control signal as a percent of the effective operating power if continuously operating at full power. The use of pulse width modulation in controlling a motor, however, involves constantly switching the voltage supply or ground to the motor leads such that the average voltage to the motor is applied in a controlled manner. The high frequency switching is filtered by the inductance of the motor and the inertia of the motor, resulting in smooth motor control. This method of pulse width modulation requires substantially less power in the amplifier.

The switching frequencies of pulse width modulation motor control, however, are usually in the 15 KHz and higher range to avoid unwanted audible noise (to Humans). To minimize power, the switching is done very quickly, causing voltage transients. These switching transients have the potential to electrically couple into the feedback signal, causing unwanted positional errors. The amplifier 84 provides a motor output signal to a motor 85 that may, for example therefore, be a pulse width modulated signal. The motor 85 is coupled to a position transducer 86 that provides feedback signals via A/D converters 87 and 88 to a position converter 89 in the feedback circuit 340. The current used by the motor is also monitored by an amplifier 90, and the output of the amplifier 90 is provided to the motor-mirror feedback unit 92 via another A/D converter 91. Status data is provided by the motor mirror feedback unit 92 to a system monitor unit 93, and the status data 26 is provided to the bus 48 via an output latch unit 94.

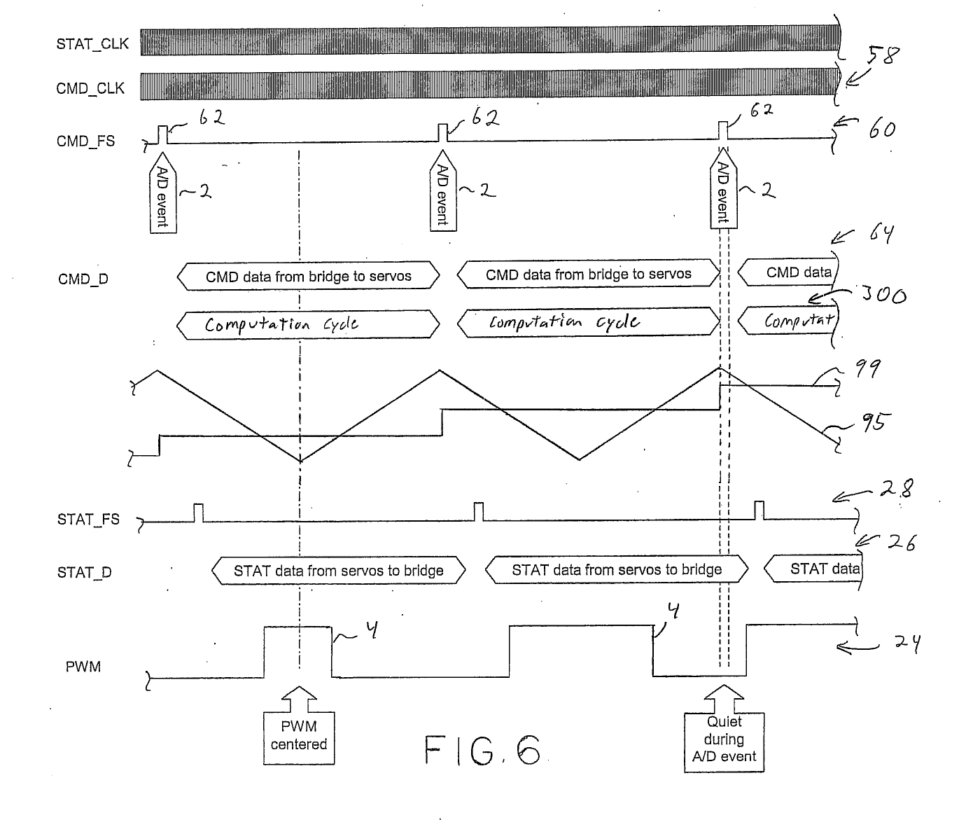

During use, the command processor 82 provides an A/D synchronization signal 95 that is used to control the timing of the amplifier output as well as the timing of the A/D converters. In particular, and as further shown at 2 in FIG. 6, the A/D conversion is designed to occur during the positive pulses of the command frame synch signal 60, while the pulses 4 of the pulse width modulated output signal 24 are designed to occur between each of the command frame synch pulses. This ensures that the A/D conversion will occur only when the motor is not being driven by a pulse width modulated signal. The A/D conversion specifically occurs when a triangle wave control signal 95 is at its maximum value as shown in FIG. 6.

The pulse width modulated signal 24 includes pulses 4 that are designed to provide pulses that are centered between each command frame synch signal, and the value of the associated output signal 99 dictates the length of time that the signal 24 is on during each frame. The pulse width modulation signal is generated by providing a positive signal 4 when the output voltage signal 99 from the control unit 83 is greater than the triangle wave control signal 95 as shown in FIG. 6. This ensures that the pulses 4 will be centered between each of the command frame synch pulses 62.

The control signal 95, therefore, synchronizes both the A/D conversions as well as the motor control signal. If the feedback sampling were at a different rate than the pulse wide modulation, then switching noise may alias down to frequencies to which the system will respond. The feedback devices, therefore, are synchronized with the cycle of the device commands, and are synchronously sampled at the same phase of the pulse width modulated waveforms on every cycle so that any switching noise coupled to the signal will be constant and will manifest itself as a DC component that may be easily be removed (or ignored). As the duty cycle of the pulses 4 of the PWM signal changes, the voltage of the PWM signal at the sample time is constant.

In further embodiments, the motor drive signal may be an analog signal rather than a pulse width modulated signal, as long as the value of the analog signal changes at specific times so that the A/D converters will not convert their analog input while the motor drive signal is changing. For example, the output circuit 330 may provide an analog drive signal that only changes value when the control signal 95 is at its lowest value in each cycle.

The command data 64 from the bus is also latched into the command processor 82 between each command frame synch pulse. As shown in FIG. 6, this ensures that each computation cycle 300 of the controller (including the steps shown at 526 and 512-518 in FIG. 5) also be completed between each command frame synch pulse 62. By synchronizing the computation cycle to the input latch, the system ensures that each input data instruction will be processed once. If the events were not synchronized, data may be missed (if the computation cycle were too long) or processed more than once (if the computation cycle were too fast).

The status frame synch signal 28 is based on (and therefore follows) the command frame synch signal 60. Status data 26 from the A/D conversions is deigned to be output to the bus 48 between each pulse of the status frame synch signal 28. The feedback status data (including for example, motor current, velocity and position) may be used to provide feedback control of the motor at the controller 80, as well as to provide status information to the central computer 38 via the HSCI bus and the bridge unit 32. The status data stream may be configured in a way similar to the command data stream in that each status frame includes a plurality of micro-vectors for each motor, except that the data will represent feedback status data. System data representative of control system information such as temperature and overall current use, may also be provided to the computer 38 via the HSCI bus and the bridge unit 32.

In particular, the motor current feedback system 90, 91 provides a motor feedback signal to the motor-mirror feedback unit 92, and the position converter unit 89 and A/D converters 87, 88 provide velocity information 6 and position information 8 to the motor-mirror feedback unit 92. The feedback unit 92 provides estimations of the motor position and mirror state, and also records current motor control, mirror velocity and mirror position signals. If preprogrammed to do so, the system provides any of the motor control, mirror velocity and mirror position signals to the system monitor unit 93, which also records the temperature and over current status. The system monitor unit 93 provides temperature and current control feedback as programmed as well. The feedback from the motor-mirror feedback unit 92 and the feedback from the system monitor unit 93 are coupled to the high speed communication interface connection system 48. This feedback may be directly coupled to any unused micro-vectors that are in the status data signal 26. For example, if eight micro-vectors are used, the first four may be assigned to the x motor controller, the y motor controller, the z motor controller and the laser controller.

The status data is provided, in accordance with an embodiment, by forming the status data as follows. Status micro-vectors are generated by the system monitor unit, and the number of status micro-vectors matches the number of command micro-vectors. The tag data bits and the controller identification bits of each command micro-vector are written into associated status micro-vectors so that the status information may be correlated with the command data that was executed contemporaneous with the status information. The desired status information, e.g., position, velocity, motor power, controller temperature and controller power, may be provided as the status data in the 24 bits of available micro-vector data. This status data is then latched onto the bus as shown at 26 by the output latch unit 94 synchronous with the status frame synch pulses 28.

In further embodiments, the x, y, z and laser command data even may be re-sent (to identify the point in time that the status data was generated), and the un-used micro-vectors from the command data may then be used for the status data relating to the controllers and/or motors. In particular, in an embodiment, four un-used micro-vectors may be used to provide status data regarding the x, y, z and laser controllers respectively. By coupling the status data in this way to the contemporaneous command data, the status data becomes tagged to the time at which each controller was executing the associated command data.

In various embodiments, the laser controller 46 may also include a status feedback system that provides feedback data synchronous with the status frame synch signal, and may be coupled to the communication bus 48 similar to the controllers 40, 42 and 44 discussed above.

As mentioned above, the generation and transmission of time sensitive data may be tagged with event markers, and the bridge unit provides that the data is stored in a first-in-first-out (FIFO) stack in each direction (to and from the computer processor 38). Gaps in transmission that might occur both to and from the computer processor 38, therefore, do not disturb the operation of the controllers 40 and 42 and the laser 44. The computer processor 38 provides substantial computational power to calculate all of the micro-vectors that are averaged over a large period of time. The bridge unit buffers sufficient micro-vectors to allow transmission on the synchronous side while lapses in data transmission occur on the asynchronous side.

Because data is buffered in the bridge by the FIFO stacks, the time between a micro-vector being generated and used is somewhat indeterminate. The time between an external event, and the associated status signal arriving at the computer would also be indeterminate if the data was not stamped (or tagged) as disclosed in more detail below. The system of tagging command and status data is employed to allow for system synchronization, data flow, and command/status correlation.

On system start up, or during operation, it may be desirable to synchronize the micro-vector command stream relative to an outside event or servo controller status. This is done by tagging micro-vectors with synchronization data. When synchronization data (e.g., a WAIT instruction) is encountered in the micro-vector command stream, the command stream will stop (and repeat the last command) until the synchronizing signal is encountered. The synchronizing signal may be from an outside source such as a switch that indicates that a positioning element for relative movement between a laser beam and a substrate (such as a stage) has stopped moving or that a laser has fired. In other embodiments, the synchronizing signal may be triggered by status information that is being continuously provided by a servo controller.

Control of execution of the micro-vectors responsive to the synchronization data may be performed at the bridge unit 32 or may be performed at each controller. A benefit of controlling the execution of the micro-vectors at the bridge unit is that the execution of all controllers may be achieved responsive to one set of synchronization data.

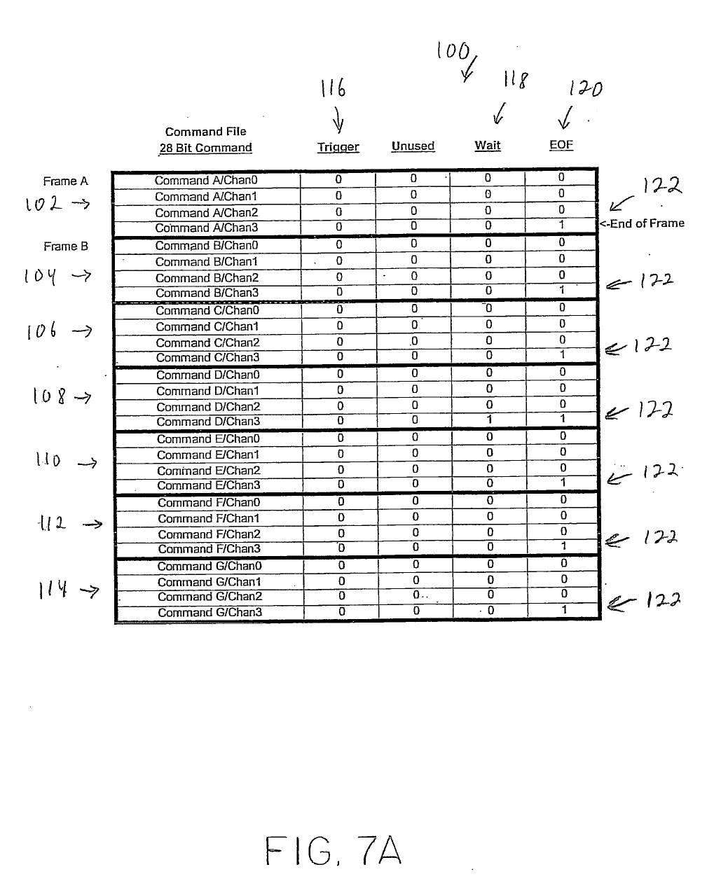

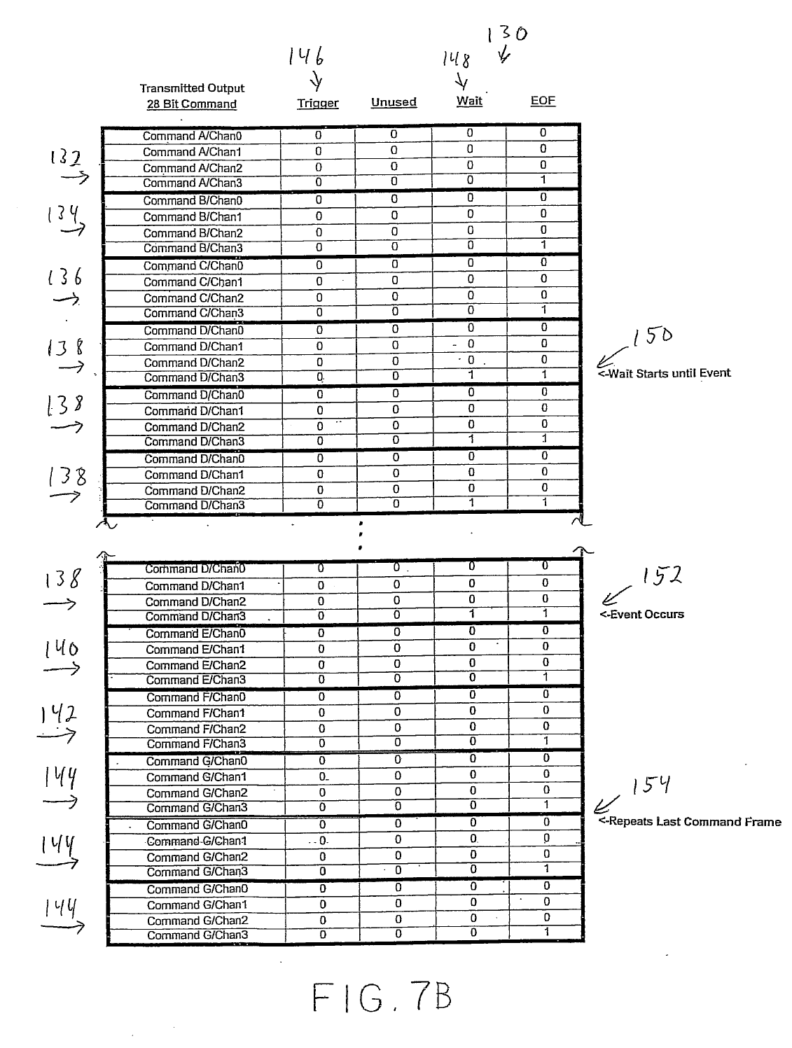

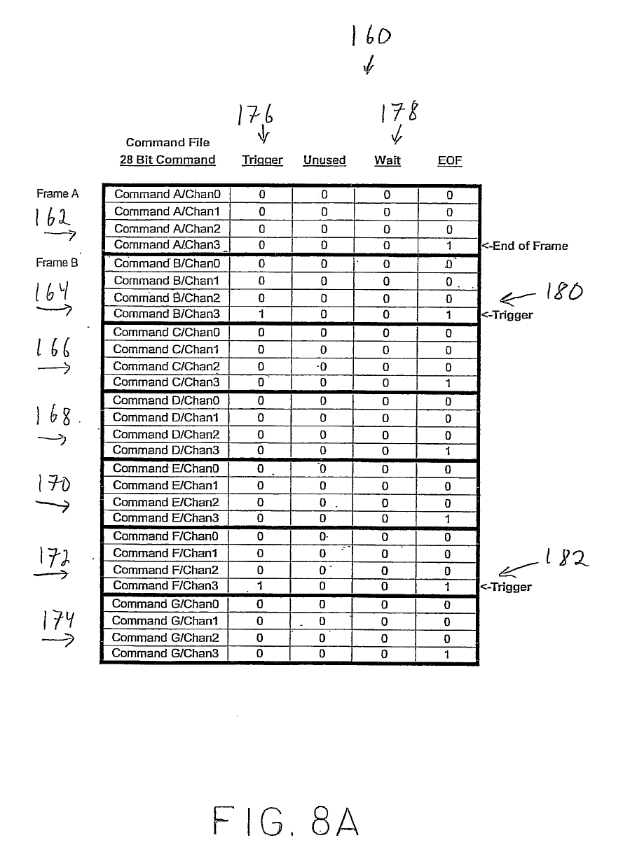

An example of the execution of a WAIT command is shown in FIGS. 7A and 7B. FIG. 7A shows at 100 a series of sets of bit commands, wherein each set includes data for each of four channels (0-3) as well as tag bits associated with each bit command. In particular, six sets of bit commands (A-G) are shown at 102, 104, 106, 108, 110, 112 and 114, and each set includes four micro-vectors. Each command is also associated with four tags bits: a trigger bit 116, an unused bit, a wait bit 118 and an end of frame bit 120. The end of frame bit is used to mark the end of each from as shown at 122.

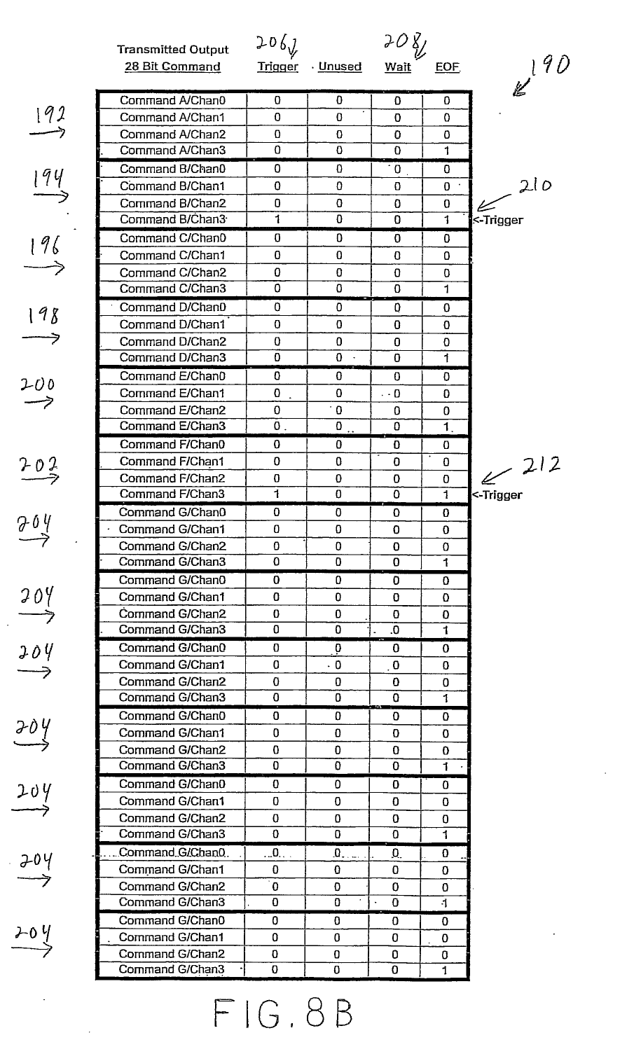

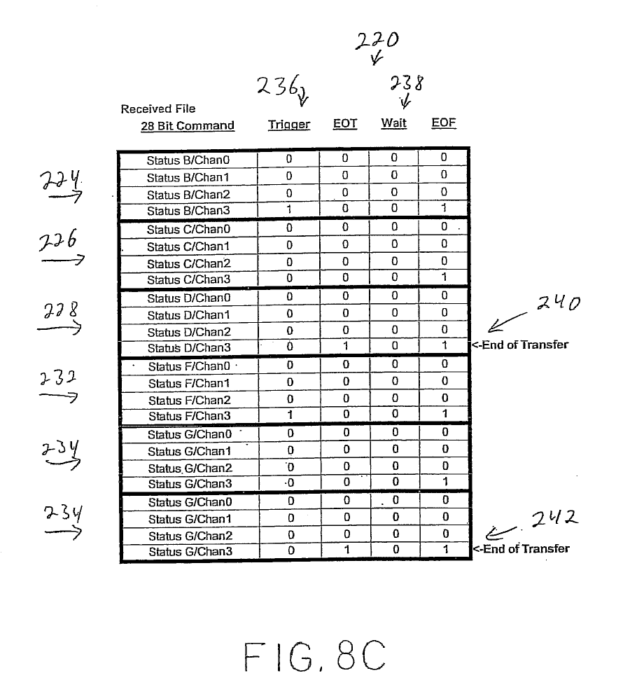

The command set 108 shown in FIG. 7A includes an enabled WAIT bit as shown in the WAIT bit column for command G. This will cause the system to wait until a pre-programmed event occurs. Such a wait instruction permits the system to be responsive to the operational environment. The wait command for example, may be used to ensure that the system (e.g., stage movement) has ceased (settled) prior to firing the laser, or may be used to confirm alignment at various times during operation. The examples shown in FIGS. 7A-7B and 8A-8C include four channels for four devices, each of which receives a micro-vector in a single frame.

As shown at 130 in FIG. 7B, the commands A-D are executed as shown at 132, 134, 136 and 138. The system then executes the command D until an external event occurs, at which time commands E, F and G are executed as shown at 140, 142 and 144. When new commands cease, the last prior command is re-sent until a new command is received. In particular, the trigger bits 146 for this example are not used, but the wait bit 148 for the command D is set, which causes the system to begin the wait as shown at 150 until a pre-programmed event occurs as shown at 152. Again, when new commands cease, the latest command (command G as shown) is repeated as shown at 154.

An example of the execution of a TRIGGER command is shown in FIGS. 8A-8C. FIG. 8A shows at 160 a series of commands and associates tag bits in which a TRIGGER bit is employed to acquire status information for one or more frames on each trigger. In the example shown, three frames are acquired on each trigger. In particular, the commands A-G are shown at 162, 164, 166, 168, 170, 172 and 174. In the trigger column 176, the TRIGGER bit for commands B and F are set as shown at 180 and 182. No wait tag bit 208 is used in this example.

During operation as shown at 206 in FIG. 8B, the commands A-G are executed (with command G repeated at the end) as shown at 192, 194, 196, 198, 200, 202, and 204. As shown at 220 in FIG. 8C, when the TRIGGER bit for command B is encountered, status information at the execution of command B is written into the first twenty four bits of command B as shown at 224 and sent back to the central computer 38. The system is programmed to acquire three frames on each trigger, so the status information at the execution of commands C and D is written into the first twenty four bits of commands C and D as shown at 226 and 228. When the trigger bit for command F occurs (as shown at 202 in FIG. 8B), the system similarly provides status information in commands F, G and G again as shown at 232 and 234, and the status information is returned to the central computer via the bridge portion. The trigger information 236 and wait information 238 are included in each status set, together with an end of trigger bit. The end of trigger bit is set as shown at 240 when the third set of status information is sent responsive to the command B trigger, and again as shown at 242 when the third set of status information is sent responsive to the command F trigger. The central computer, therefore, is able to associate each set of status information with the command that was executed at the time of generation of the status information.

The system illustrated above operates in real time, and operates continuously. In certain applications, it may be desirable to change the size of the command micro-vector during operation to add or remove additional axis. By tagging the last micro-vector in each set with an end of frame tag, the system knows where each frame ends and may modify the size of each frame and/or add new micro-vectors to each frame during operation. The system will first generate the data and then automatically provide the data in the sample period to the synchronous bus while the length of the vector is increased or decreased without any danger of a micro-vector being unloaded in the wrong time frame.

The status data written onto the micro-vectors may be used to provide a wide range of programmable status information, and may be readily correlated with the associated command that is executed at the time of generation of the status information. In most cases, there is no need for a continual stream of status data for each micro-vector, and the trigger command is used to gate in status information at specific times. In this manner, data driven status collection is achieved. An example of when this might be useful is if the step response for an axis is desired. The central computer would stamp the step command data and some time period later with transmit an enable signal. Each micro-vector command executed with this stamp will cause a status to be transmitted back to the central computer.

Those skilled in the art will appreciate that numerous modifications and variations may be made to the above disclosed embodiments without departing from the spirit and scope of the invention.

What is claimed is:

1. A control system for controlling the movement of a limited rotation motor, said control system comprising:
a computer system for generating command digital data including digital input commands for controlling the movement of the limited rotation motor; and
a closed-loop motor controller including an input circuit for receiving the command digital data synchronous with a data input signal, a digital control system for processing the command digital data, an output circuit for providing a motor drive signal to the limited rotation motor, and a feedback circuit for providing digital feedback data to said digital control processing circuit, said digital control processing circuit providing closed-loop motor control calculations on a computation cycle that is synchronous with the data input signal.

2. The control system as claimed in claim 1, wherein said output circuit is synchronous with said feedback circuit such that feedback circuit input data is read from the limited rotation motor only when the motor control signal is not changing.

3. The control system as claimed in claim 1, wherein said command digital data is asynchronous when generated by said computer system, and said control system further includes a bridge system for receiving the asynchronous command digital data and for providing synchronous command digital data to said closed-loop control system.

4. The control system as claimed in claim 3, wherein feedback data is provided from the closed-loop control system to the computer system via the bridge system.

5. The control system as claimed in claim 3, wherein feedback data is provided from the closed-loop control system to the computer system, and wherein said feedback data is associated with a specific set of command digital data.

6. The control system as claimed in claim 1, wherein said motor drive signal is an analog signal.

7. The control system as claimed in claim 1, wherein said motor drive signal is a pulse width modulated signal.

8. The control system as claimed in claim 7, wherein said control system includes a plurality of closed-loop motor controllers for controlling the movement of a plurality of limited rotation motors, wherein each closed-loop motor controller provides closed-loop motor control calculations on a computation cycle that is synchronous with the data input signal.

9. A control system for controlling the movement of a limited rotation motor, said control system comprising:
a computer system for generating command digital data for controlling the movement of the limited rotation motor; and
a closed-loop motor controller including an input circuit for receiving the command digital data, a digital control processing circuit for processing the command digital data, an output circuit for providing a motor drive signal to the limited rotation motor, and a feedback circuit for providing feedback digital data to the digital control system, said output circuit being synchronous with said feedback circuit such that feedback input data is read from the limited rotation motor only when the motor control signal is not changing.

10. The control system as claimed in claim 9, wherein input circuit receives the command digital data synchronous with a data input signal, and said digital control processing circuit provides closed-loop motor control calculations on a computation cycle that is synchronous with the data input signal.

11. The control system as claimed in claim 9, wherein said command digital data is asynchronous when generated by said computer system, and said control system farther includes a bridge system for receiving the asynchronous command digital data and for providing synchronous command digital data to said closed-loop control system.

12. The control system as claimed in claim 11, wherein feedback data is provided from the closed-loop control system to the computer system, and wherein the feedback data is associated with a specific set of command digital data.

13. The control system as claimed in claim 9, wherein said motor drive signal is a pulse width modulated signal.

14. A control system for controlling the movement of a limited rotation motor, said control system comprising:
a computer system for generating command digital data including digital input commands for controlling the movement of the limited rotation motor; and
a closed-loop motor control system including a buffer circuit for receiving the command digital data, a digital control processing circuit for processing the command digital data, an output circuit for providing a motor drive signal to the limited rotation motor, and a feedback circuit for providing feedback data to the digital control system;
wherein said command digital data further includes instruction data, and wherein operation of the closed-loop motor control system is responsive to the instruction data.

15. The control system as claimed in claim 13, wherein said instruction data causes the closed-loop motor control system to perform a WAIT instruction such that advancement to a next position command is stopped until a pre-defined event signal is set.

16. The control system as claimed in claim 15, wherein said pre-defined event signal includes information representative of a state of readiness of at least one of a laser and a positioning element for relative movement between a laser beam and a substrate.

17. The control system as claimed in claim 13, wherein said instruction data causes the closed-loop motor control system to perform a TRIGGER instruction such that at least one pre-defined event occurs within the closed-loop motor control system responsive to the TRIGGER instruction.

18. The control system as claimed in claim 17, wherein said pre-defined event includes a request for specific status information from the closed-loop motor controller.

19. A method of controlling movement of a limited rotation motor, said method comprising the steps of:
generating command digital data including digital input commands for controlling the movement of the limited rotation motor;
generating a timing signal;
executing closed-loop motor control calculations responsive to each digital input command on a computation cycle that is synchronous with the timing signal to provide an motor drive signal for controlling the movement of the limited rotation motor; and
receiving feedback information from the limited rotation motor such that said closed-loop motor control calculations are responsive to each digital input command and responsive to the feedback information from the limited rotation motor.

20. The method as claimed in claim 19, wherein said feedback information received from the limited rotation motor is received synchronously with the motor drive signal such that the feedback information is not received from the limited rotation motor while the motor drive signal is changing.

21. The method as claimed in claim 19, wherein said command digital data is asynchronous when generated, and said method further includes the steps of:
providing said asynchronous command digital data to a bridge system; and
providing synchronous command digital data from the bridge system to a closed-loop motor controller that executes the motor control calculations.

22. The method as claimed in claim 21, wherein said closed-loop motor controller provides status digital data to a computer system and wherein the status digital data is associated with a specific set of command digital data.
